(19) United States
(12) Patent Application Publication
(10) Pub. No.: US 2026/0004370 A1
(43) Pub. Date: Jan. 1, 2026

(54) Inventor Disclosure Recording and Reporting (IDRR)

(71) Applicant: PDE Technologies Inc, Pembroke, GA (US)

(72) Inventors: SUDIPTA BHAWMIK, BRIDGEWATER, NJ (US); ANINDYO SARKAR, KATY, TX (US); WILLIAM L. DOWNS, PEMBROKE, GA (US); PABITRA KUMAR Chakrabarty, Fairfax, VA (US)

(21) Appl. No.: 18/207,659

(22) Filed: Jun. 8, 2023

Related U.S. Application Data
(60) Provisional application No. 63/350,644, filed on Jun. 9, 2022.

(51) Int. Cl. G06Q 50/18; G06F 16/2458

(52) U.S. Cl. CPC G06Q 50/184; G06F 16/2465; G06F 2216/11

(57) ABSTRACT

An inventor disclosure recording and reporting system and method. The system includes a digital framework configured to perform a cost saving or a time saving task for an inventor. The digital framework includes a data services module configured to record, store, process and report data related to an invention disclosure of an inventor. The digital framework also includes an ideation and patentability module configured to compare and contrast the data with prior information available from a pre-existing knowledgebase, and report at least one of a similarity status, an obviousness status, and a patentability status of the invention disclosure. The digital framework further includes a provisional patent filing module configured to draft a paper copy and a digital copy of a provisional patent application related to the invention disclosure, based on at least one of the similarity status, the obviousness status, and the patentability status of the invention disclosure. The digital framework also includes a non-provisional patent filing assistance module configured to draft a paper copy and a digital copy of a non-provisional patent application related to the invention disclosure, based on at least one of the similarity status, the obviousness status, and the patentability status of the invention disclosure. The digital framework further includes a patent monetization aid module configured to compute and report a financial currency converted value of the invention disclosure, based on at least one of the similarity status, the obviousness status, and the patentability status of the invention disclosure. The digital framework also includes a patent obsolescence planning module configured to analyze, compute and report a plurality of future states of a subject matter described in the invention disclosure and a patent portfolio management module configured to analyze, compute and report a plurality of portfolio jurisdictions related to each of the future states of the subject matter described in the invention disclosure.

### CROSS-REFERENCE TO RELATED APPLICATIONS

This non-provisional patent application claims the benefit of priority to U.S. Provisional patent Application No. 63/350,644, filed on Jun. 9, 2022, the entire contents of which are incorporated herein by reference and should be considered part of this specification.

### TECHNICAL FIELD

The present invention relates generally to recording and reporting inventors' disclosures, and specifically to recording and reporting inventors' disclosures through iterative interactions with the inventors.

### DETAILED DESCRIPTION OF THE INVENTION

Growth in global entrepreneurship has caused an exponential rise in demand for applications to help obtain IP protection in the US. Current methods and processes for patenting and IP protection filing are painfully slow and inefficient. IP law firms, consulting firms, and corporate counsels are overwhelmed with caseloads. Further exacerbating the problem. The current situation has fueled the need for a smart software service that can take over the bulk of the patent process for inventors.

The ‘Inventor Disclosure Recording and Reporting’ (IDRR) System and Method of the current application fulfill these needs by leveraging AI (artificial intelligence)/ML (machine learning)/NLP (natural language processing) technology, cloud computing, and high-performance computing platforms to quickly and efficiently aid inventors with the patent process.

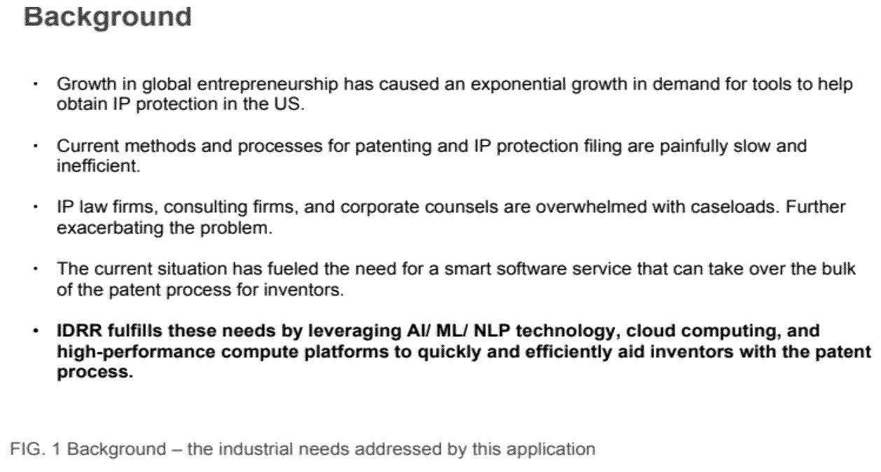

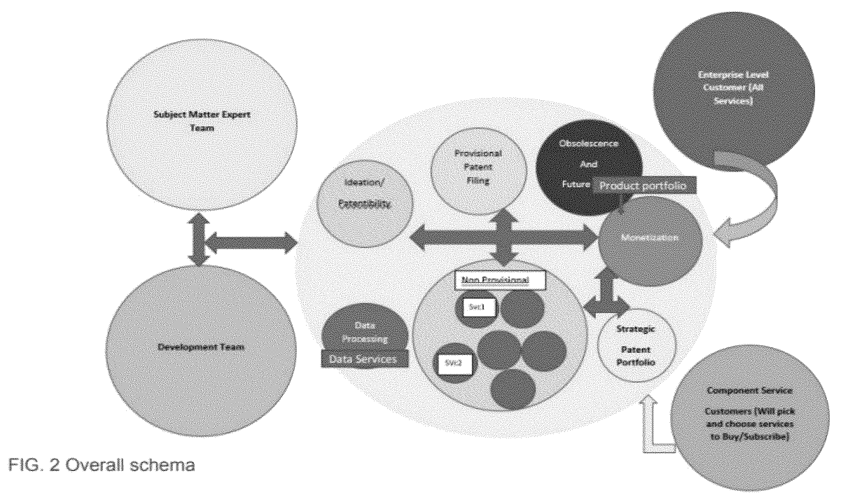

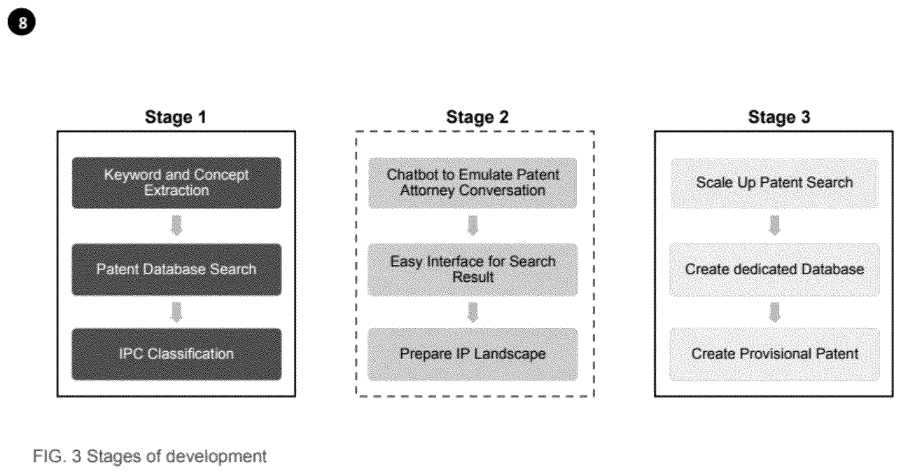

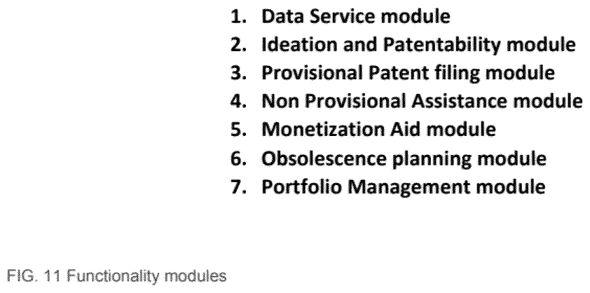

FIGS. 1 to 44 illustrate schematic representations of an exemplary recording and reporting system for inventors' disclosures. Specifically, FIG. 1 illustrates the background in terms of the industrial needs addressed by this application. FIG. 2 illustrates a schematic representation of an exemplary framework of the recording and reporting system for inventors' disclosures. FIGS. 3 to 10 illustrate schematic representations of an exemplary architecture of the recording and reporting system for inventors' disclosures. FIGS. 11 to 41 illustrate schematic representations of several non-limiting and exemplary functionalities of the recording and reporting system for inventors' disclosures.

Referring to FIG. 2, the IDRR system includes a digital framework configured to perform a cost-saving or a time-saving task for an inventor. The digital framework includes a data services module configured to record, store, process, and report data related to an invention disclosure of an inventor. The digital framework also includes an ideation and patentability module configured to compare and contrast the data with prior information in text, image, and diagram form, available from a pre-existing knowledgebase, and report at least one a similarity status, an obviousness status, and a patentability status of the invention disclosure. The digital framework further includes a provisional patent filing module configured to draft a paper copy and a digital copy of a provisional patent application related to the invention disclosure, based on at least one of the similarity status, the obviousness status, and the patentability status of the invention disclosure. The digital framework also includes a non-provisional patent filing assistance module configured to draft a paper copy and a digital copy of a non-provisional patent application related to the invention disclosure, based on at least one of the similarity status, the obviousness status, and the patentability status of the invention disclosure. The digital framework further includes a patent monetization aid module configured to compute and report a financial currency converted value of the invention disclosure, based on at least one of the similarity status, the obviousness status, and the patentability status of the invention disclosure. The digital framework also includes a patent obsolescence planning module configured to analyze, compute and report a plurality of future states of a subject matter described in the invention disclosure and a patent portfolio management module configured to analyze, compute and report a plurality of portfolio jurisdictions related to each of the future states of the subject matter described in the invention disclosure.

Referring to FIG. 3, there are three stages of development of the application. In the first stage, a number of keywords and concepts are extracted from the invention disclosure. These keywords and concepts are subsequently searched in a patent and/or non-patent and/or publication/literature database or knowledgebase. The search will also involve searching images and diagrams besides texts. Based on the search and the results, one or more IPC (International Patent Classification) class(es) is/are assigned to the invention disclosure. In the second stage, a chatbot is programmed to emulate a typical inventor's conversation with a patent agent or a lawyer and accordingly an easy-to-use user interface is built to display, present and report the search results. An IP Landscape is subsequently constructed, presented and reported to the inventor. In the third stage, the patent search process is scaled up and enhanced, and a value-added, dedicated database is created. Finally, a print copy and/or digital copy of a provisional patent is drafted based on the value-added, dedicated database.

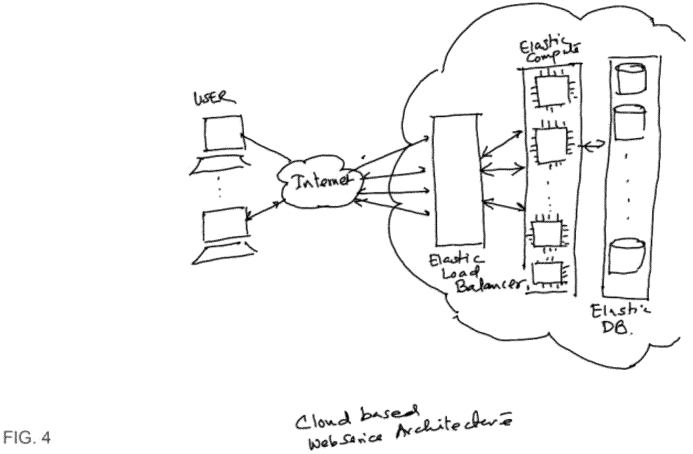

Referring now to FIG. 4 shows the cloud architecture used to deploy the system. The cloud-based architecture consists of basically three tiers. A load balancer accepts requests from the internet and then sends those requests to appropriate compute servers. The compute servers run the code, of the system. The number of compute servers will depend on the overall load. The compute server in turn refers to the database servers because most of the content like the patent database or the user database, the concept-graph, or Knowledge Graph, are represented in databases and accessed by the compute servers. Hence the key components of the cloud architecture consist of the load balancer, the compute servers, and the database service.

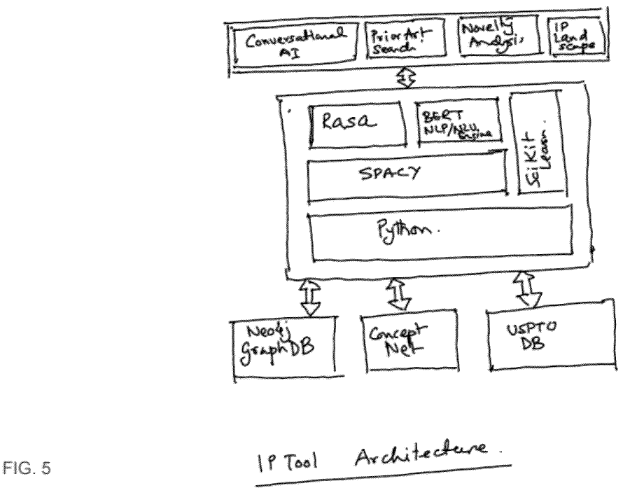

Referring to FIG. 5 shows the basic IP architecture including the frameworks used to implement the overall system. In this figure, at the top, we see the basic functional layers which consist of the conversational AI (or Chatbot), prior art search, novelty analysis, and IP landscape analysis. In the bottom layer, we have the infrastructural databases that we use, the Neo4j graph database, the concept net which is essentially a knowledge graph (that explains the different concepts and terms), and then the US Patent database, which is essentially the prior-art database. The centerpiece shows the different frameworks and technologies used by this app. The entire system is developed using the Python language. We use other frameworks like Spacey natural language processing framework, Scikit-Learn, Bert NLP and NLU engine for concept analysis, and Rasa for conversational AI bot.

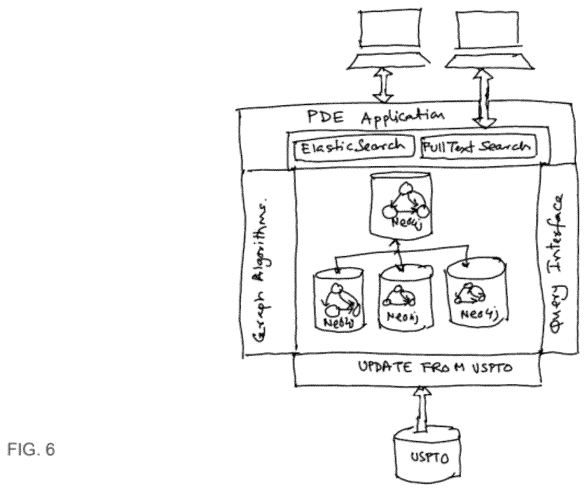

Referring to FIG. 6 shows how we are leveraging the graph database. In order to make it fail-safe, there are multiple instances of the graph database running in master-slave configuration. The master instance controls “read” and “write” and all the slaves are in “read” mode. The graph database architecture allows a flexible and efficient search process. The graph database is updated from the USPTO. The database supports graph algorithms, such that we can do graph similarity analysis and graph searches. Elastic Search and full-text search are used to query the graph databases.

Referring to Figure seven shows a basic flow a high-level flow of the system. In the first step, we interview the inventor to understand what is the problem and what solution the inventor is proposing? What are the basic features of the solution? And from that, in the next step, the system extracts the key concepts and the key phrases that are patentable. In the next step we a prior art search, then analyze the prior art to find those with the highest similarity score. We then try to assess the novelty based on that analysis that is, the less the similarity the more novel solution is. Next, we check for non-obviousness as to whether a single patent or multiple patents can make the proposed solution as obvious.

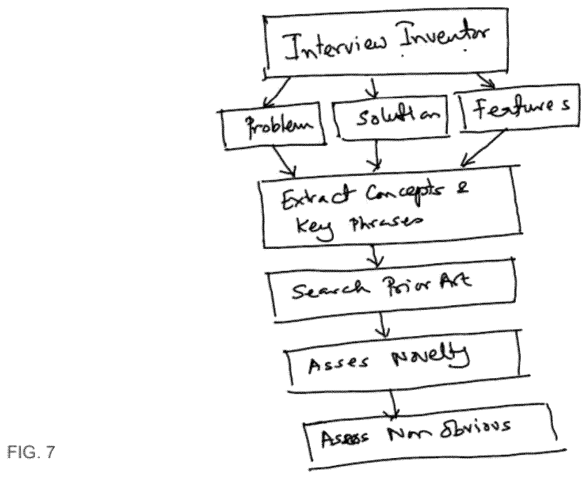

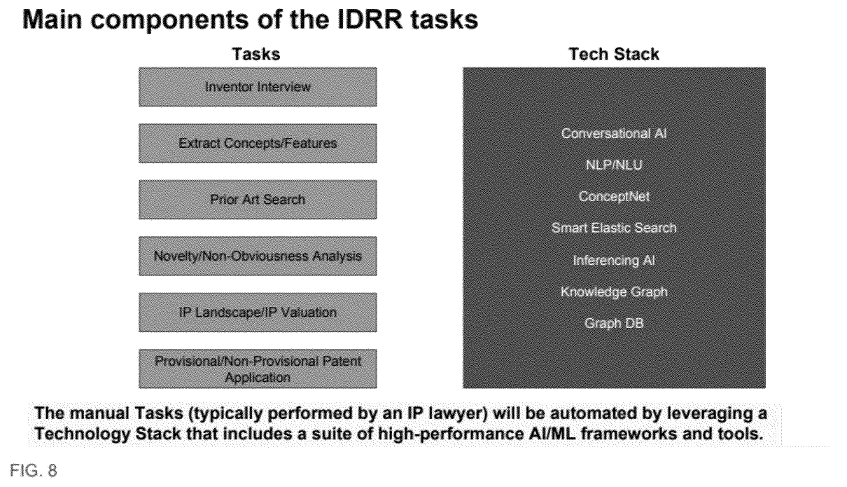

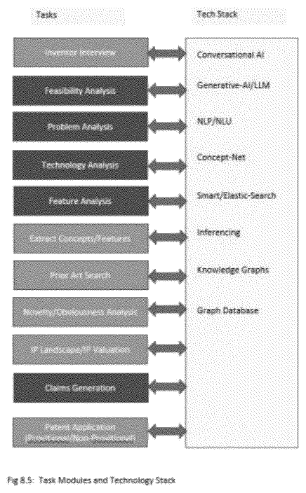

Referring to FIG. 8 talks about the same thing as FIG. 7 plus a couple of more steps that we expect to implement. One is IP landscape and IP valuation analysis. The final outcome of this entire process is to generate a provisional and non-provisional patent application. The technology stack used in to implement all this consists of conversational AI, NLP, concept net, Smart Search Knowledge Graph, and cloud database.

FIG. 8.5 is an extension of FIG. 8 wherein 5 more additional modules are used.

Feasibility Analysis module uses Generative-AI/Large Language Models (LLMs) to read the invention disclosure and determine if the idea is feasible. This step ensures that the idea is practical and can be implemented.

Problem Analysis module also uses Generative-AI/LLM to analyze the idea to determine what problem this idea tries to solve and why is this a problem This gives the user the utility of the idea and can be included in the final patent application.

Technology Analysis module (also leverages Generative-AI/LLM) analyzes the idea to categorize the disclosure as to which technology domain this invention belongs. It also determines the industries where the invention may be used and suggests the specific companies that might be interested in using the invention.

Feature Analysis module uses Generative-AI/LLM to rewrite the invention disclosure as a list of features. This list allows the inventor to determine if the disclosure is complete and includes all the key distinguishing features.

Claims Generation module leverages Generative-AI/LLM technology to write a list of claims that the inventor might use in his/her patent application.

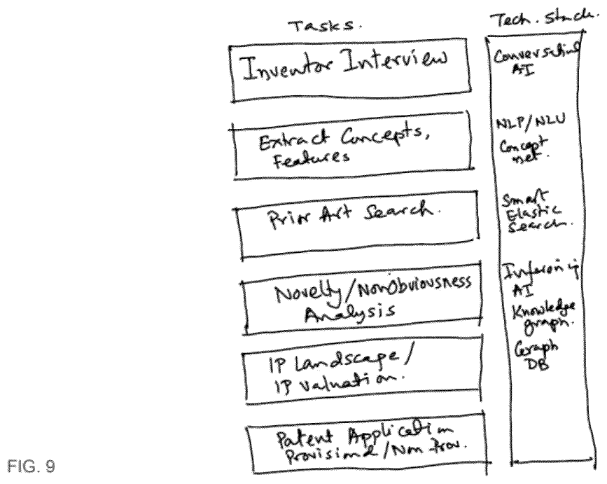

Referring to FIG. 9 is essentially the flow for conversational AI. It shows the flow of conversation as that typically the system or the Chatbot or the conversational AI handles, which starts with a greet and then goes through the various steps and takes decisions based on the intent expressed in the user inputs in the form of sentences or conversations.

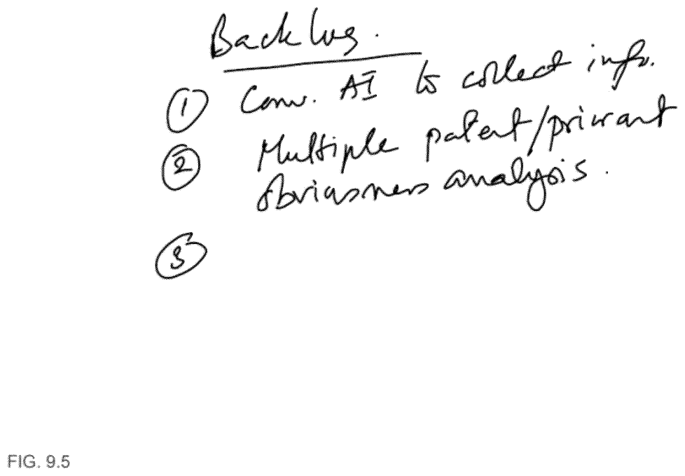

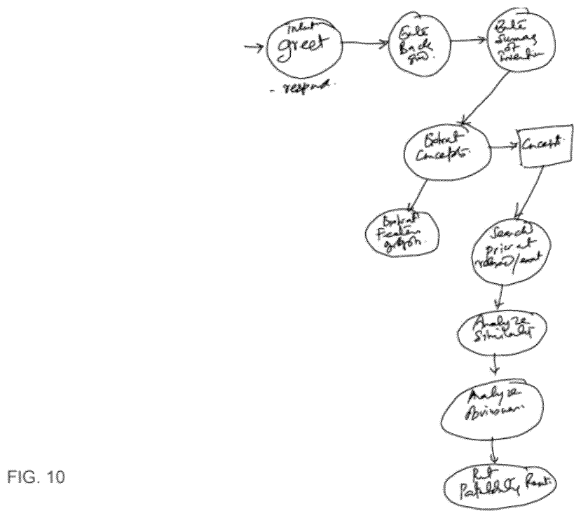

FIG. 10 schematically illustrates several non-limiting and exemplary functionalities of the recording and reporting system for inventors' disclosures. Some of the exemplary modules and their functionalities are:
(a) Data Services module that typically records, stores, processes, and reports data related to an invention disclosure of an inventor. Further details of this module have been disclosed in the documents listed in the Appendix.
(b) Ideation and Patentability module that typically compares and contrasts the data with prior information available from a pre-existing knowledge base, and reports at least one a similarity status, an obviousness status, and a patentability status of the invention disclosure. Further details of this module have been disclosed in the documents listed in the Appendix.
(c) Provisional Patent filing module that typically drafts a paper copy and a digital copy of a provisional patent application related to the invention disclosure, based on at least one of the similarity status, the obviousness status, and the patentability status of the invention disclosure. Further details of this module have been disclosed in the documents listed in the Appendix.
(d) Non-Provisional Assistance module that typically drafts a paper copy and a digital copy of a non-provisional patent application related to the invention disclosure, based on at least one of the similarity status, the obviousness status, and the patentability status of the invention disclosure. Further details of this module have been disclosed in the documents listed in the Appendix.
(e) Monetization Aid module that typically computes and reports a financial currency converted value of the invention disclosure, based on at least one of a similarity status, an obviousness status, and a patentability status of the invention disclosure. Further details of this module have been disclosed in the documents listed in the Appendix.
(f) Obsolescence planning module that typically analyzes, computes and reports a plurality of future states of a subject matter described in the invention disclosure, using an S-curve model of organic growth. Further details of this module have been disclosed in the documents listed in the Appendix.
(g) Portfolio Management module that typically analyzes, computes and reports a plurality of portfolio jurisdictions related to each of the future states of the subject matter described in the invention disclosure. Further details of this module have been disclosed in the documents listed in the Appendix.

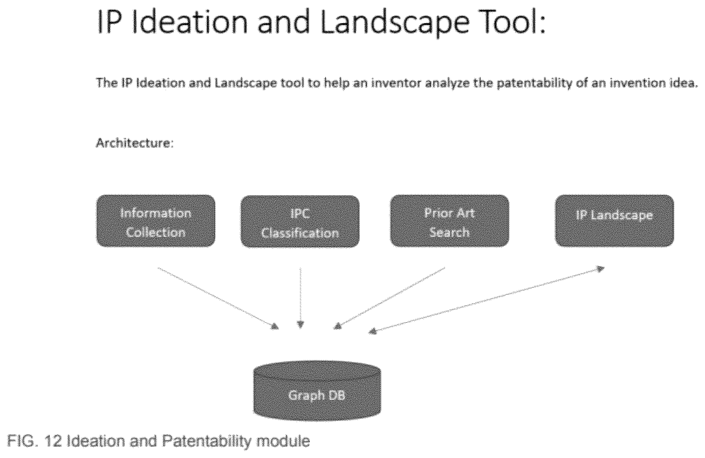

FIG. 11 provides the main components of the IDRR tasks alongside the Tech Stack showing the Tech Stack with some of the tools in use. This Figure provides same information as FIG. 8. FIG. 12 schematically illustrates the working details of the Ideation and Patentability module. Information collected from the inventor, in the form of the invention disclosure, are consolidated with relevant prior art (patents as well as non-patent publication) information and IPC Classification details to construct industry standard IP Landscapes.

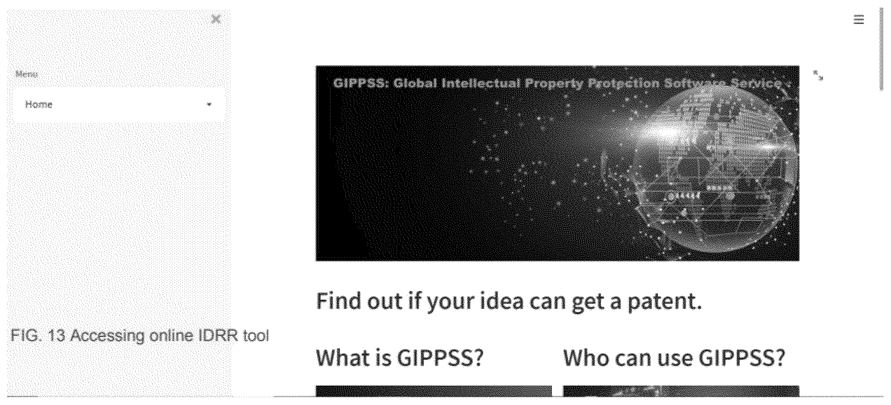

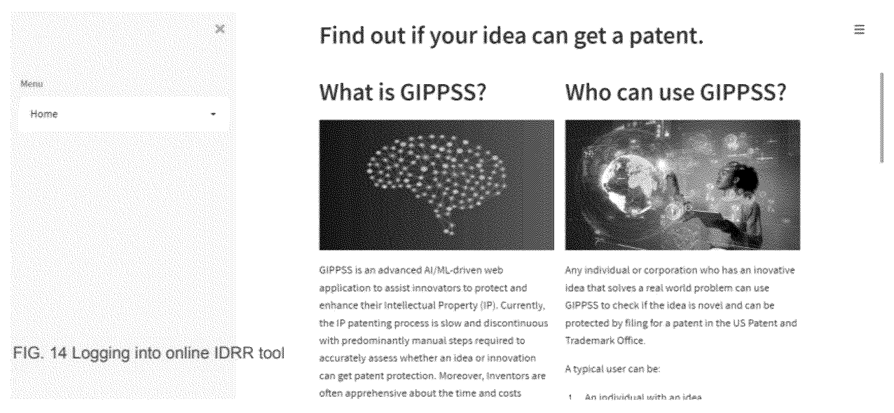

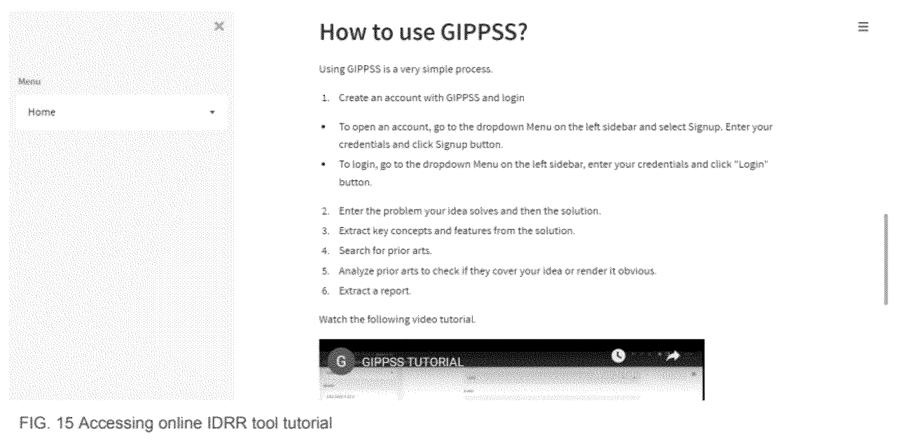

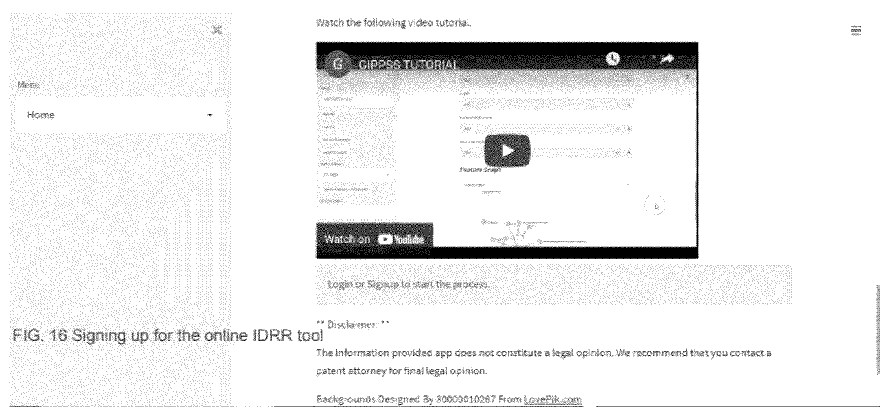

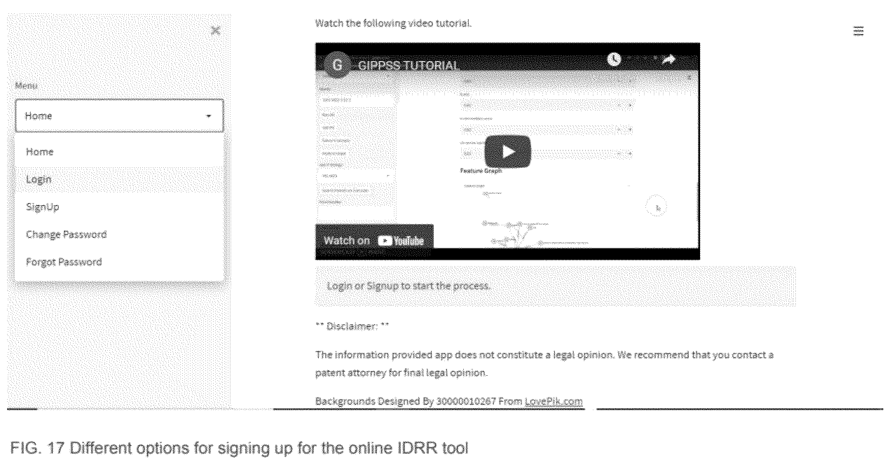

FIG. 13 is a pictorial representation of accessing the online IDRR application. The application is digitally hosted on a secure website and accessed by an inventor or would-be inventor having appropriate authentication. FIG. 14 illustrates a pictorial representation of the process of an inventor logging into the online IDRR application, in order to record, analyze and report his/her invention disclosure. FIG. 15 illustrates a pictorial representation of an online tutorial that trains the user/inventor on accessing and utilizing the functionalities of the online IDRR application. FIG. 16 illustrates a pictorial representation of the sign-up or log-in step for the user/inventor. FIG. 17 illustrates a pictorial representation of all different options available to the user/inventor after signing up on the online IDRR tool.

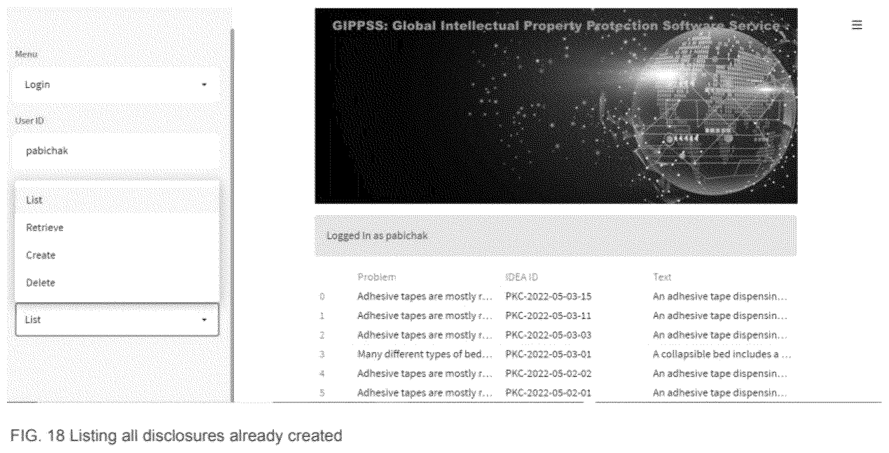

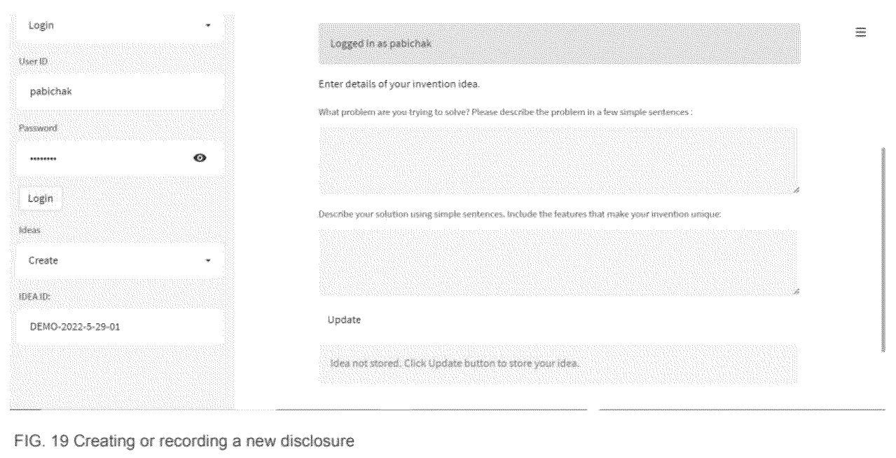

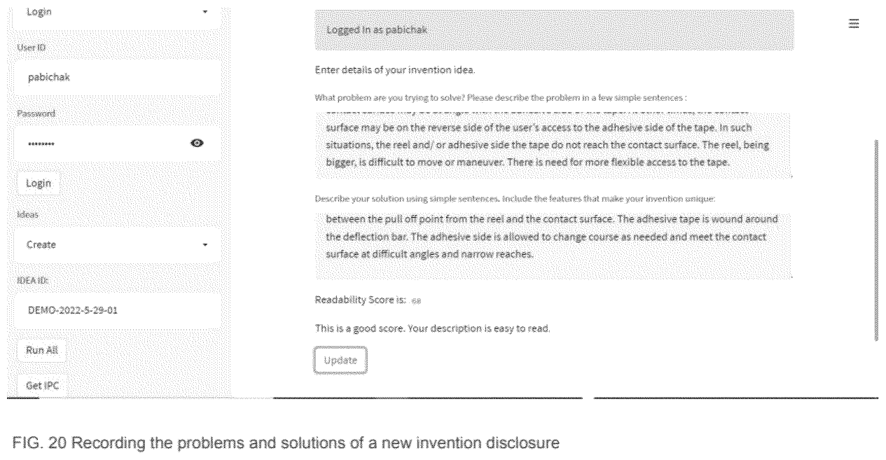

FIG. 18 is a pictorial representation of all disclosures already created by a returning user/inventor. FIG. 19 illustrates a pictorial representation of creating or recording a new disclosure on the IDRR application. FIG. 20 illustrates a pictorial representation of a recording process for the problems and solutions, on the IDRR application, as is part of a new invention disclosure process. A ‘readability score’ is generated at the end of this step that reflects the spelling and grammatical accuracy as is necessary for general readability or comprehensibility of the text entered to define the problems and solutions of the invention disclosure. In one embodiment, there may be a minimum and/or maximum word limit associated with the text for the problems and solutions of the invention disclosure.

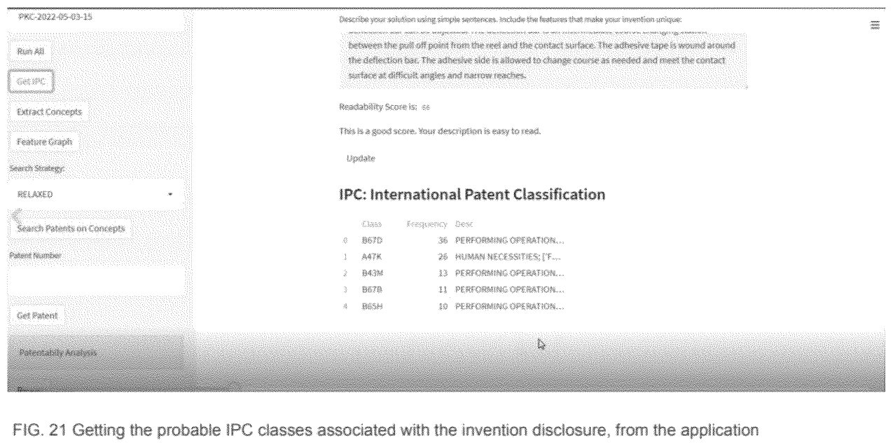

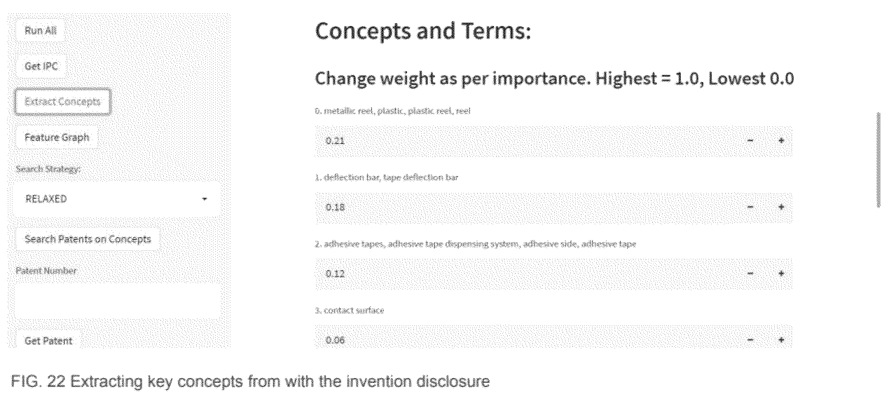

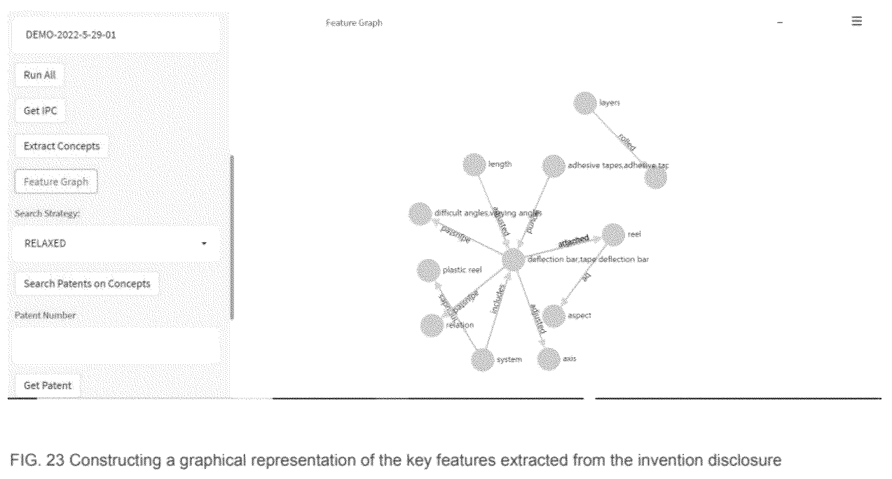

FIG. 21 is a pictorial representation of the IDDR application associating one or more probable IPC classes with the invention disclosure. FIG. 22 illustrates a pictorial representation of the step of extracting a number of key concepts from the invention disclosure. FIG. 23 illustrates a pictorial representation of the step of constructing a graphical representation of the key features extracted from the invention disclosure.

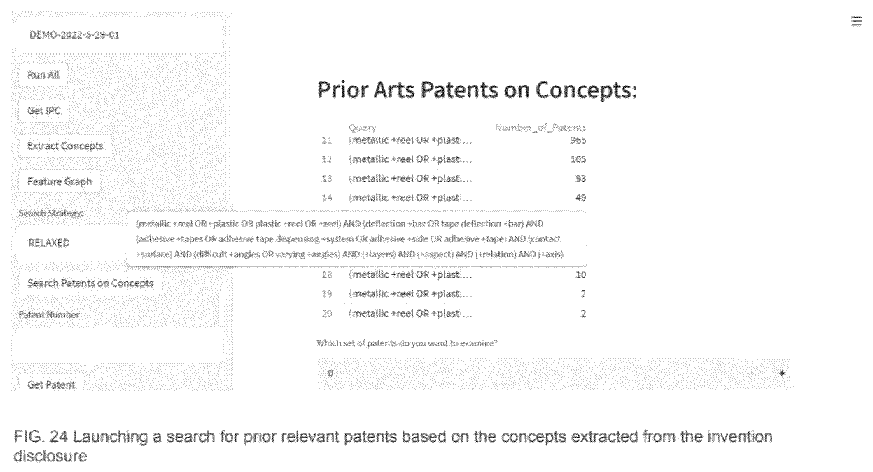

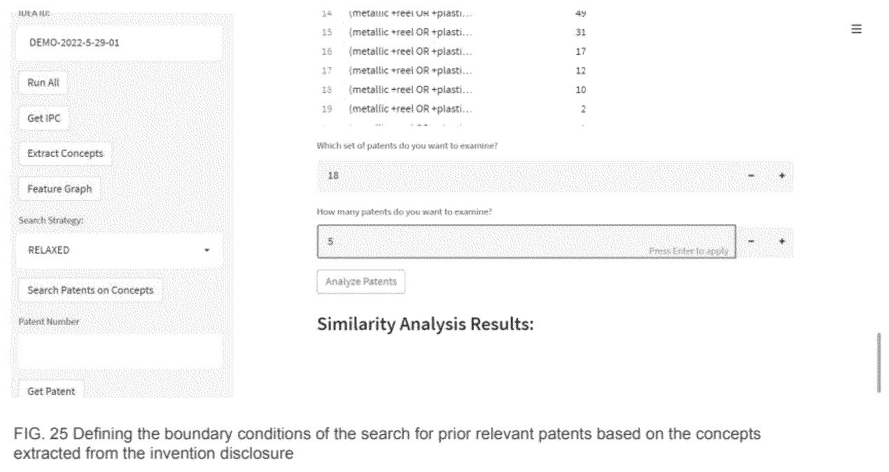

FIG. 24 is a pictorial representation of the step of launching a search for prior relevant patents based on the concepts extracted from the invention disclosure. FIG. 25 illustrates a pictorial representation of the step of defining the boundary conditions of the search for prior relevant patents based on the concepts extracted from the invention disclosure, as in FIG. 24.

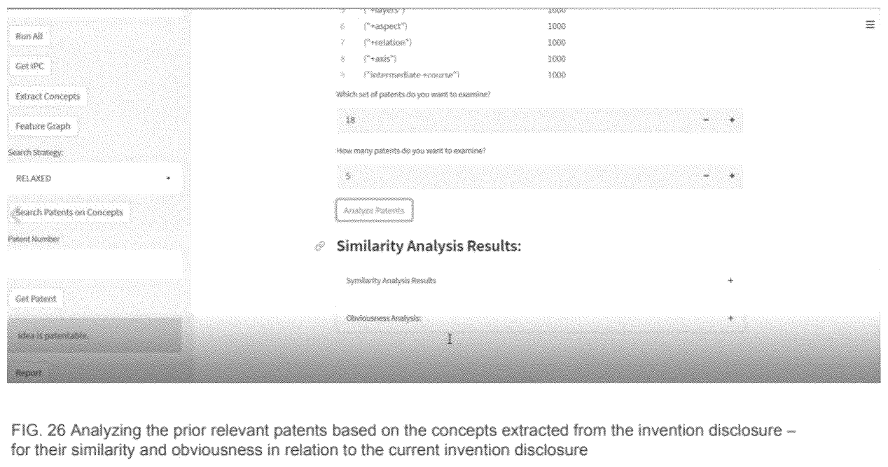

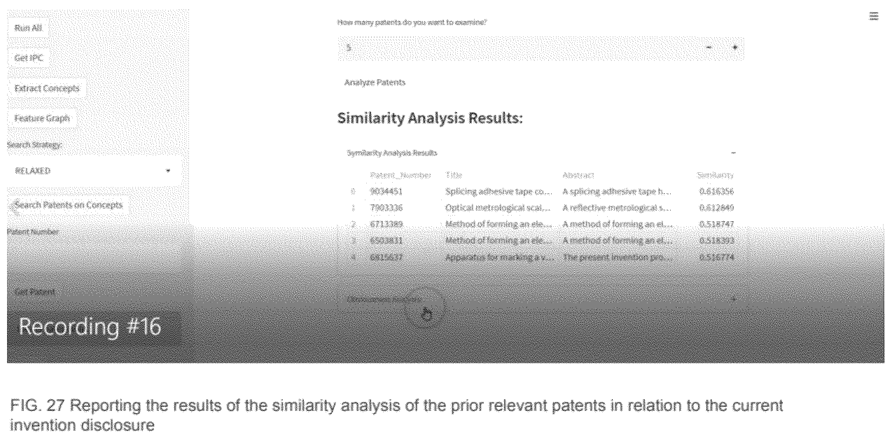

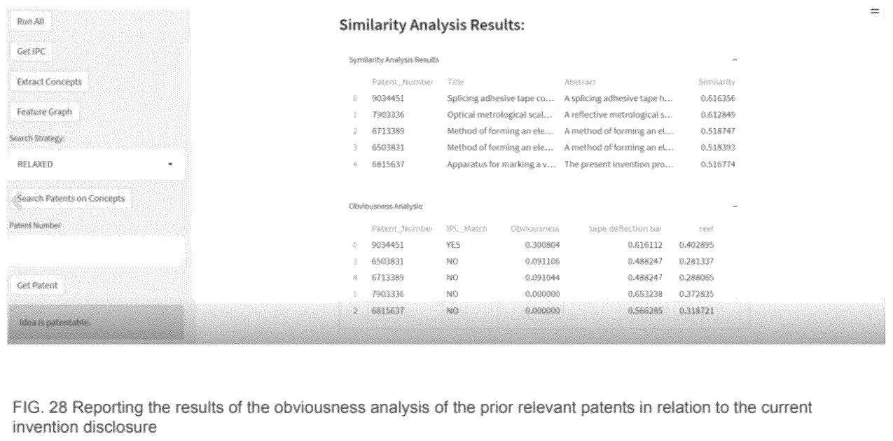

FIG. 26 is a pictorial representation of the step of analyzing the prior relevant patents based on the concepts extracted from the invention disclosure—for their similarity and obviousness in relation to the current invention disclosure. FIG. 27 illustrates a pictorial representation of the step of reporting the results of the similarity analysis of the prior relevant patents in relation to the current invention disclosure. FIG. 28 illustrates a pictorial representation of the step of reporting the results of the obviousness analysis of the prior relevant patents in relation to the current invention disclosure.

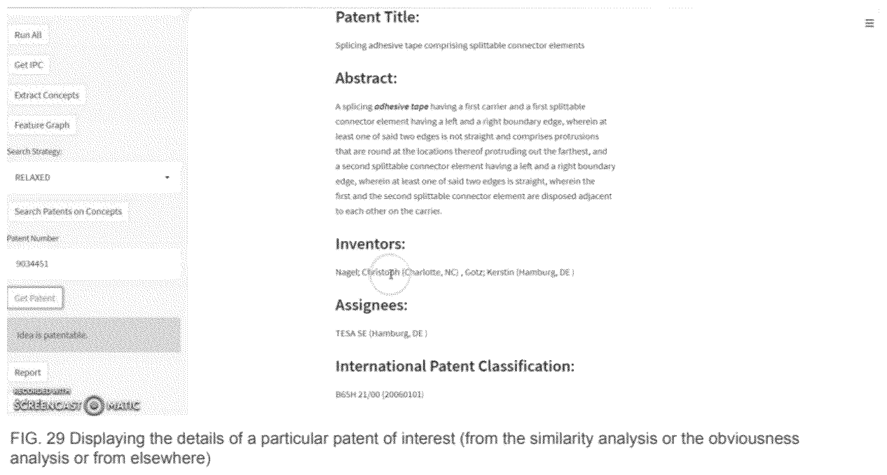

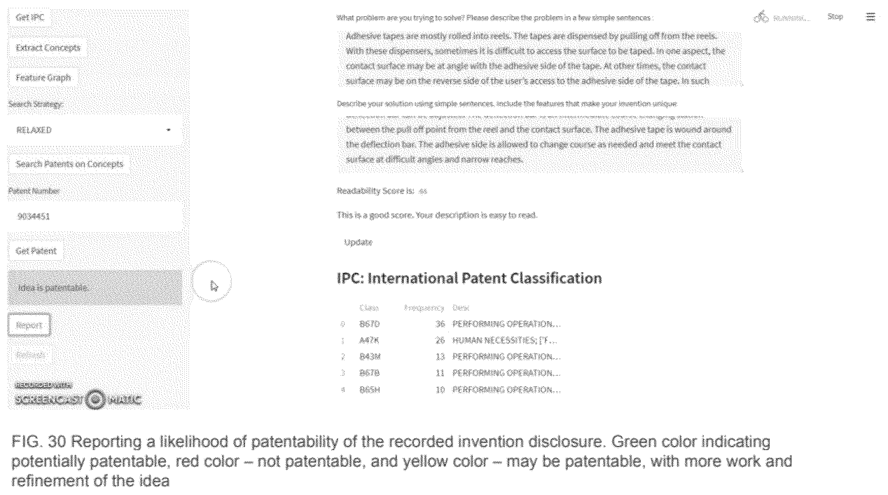

FIG. 29 is a pictorial representation of the step of displaying the details of a particular patent of interest (from the similarity analysis or the obviousness analysis or from elsewhere). FIG. 30 illustrates a pictorial representation of the step of reporting a likelihood of patentability of the recorded invention disclosure. Green color indicates potentially ‘patentable’, red color indicates ‘not patentable’, and yellow color indicates ‘may be patentable’, with more work and refinement of the idea.

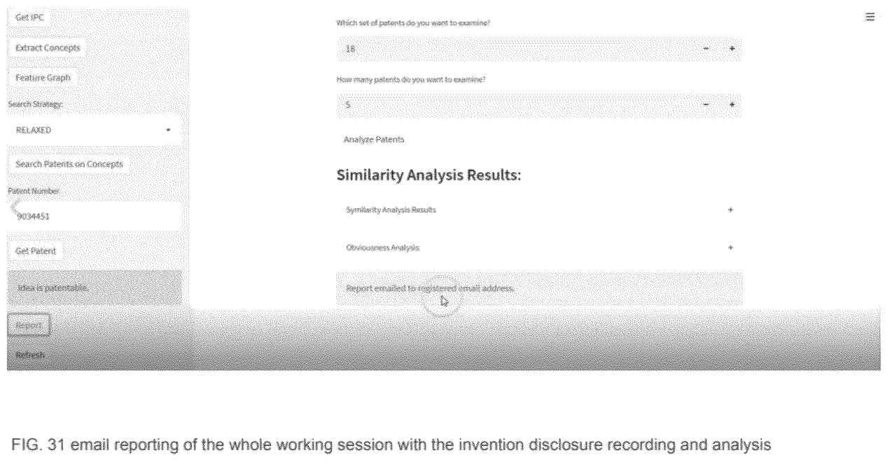

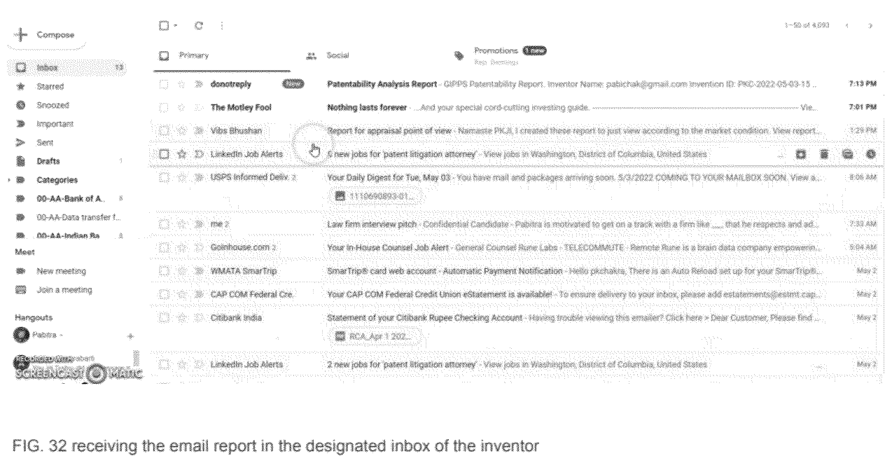

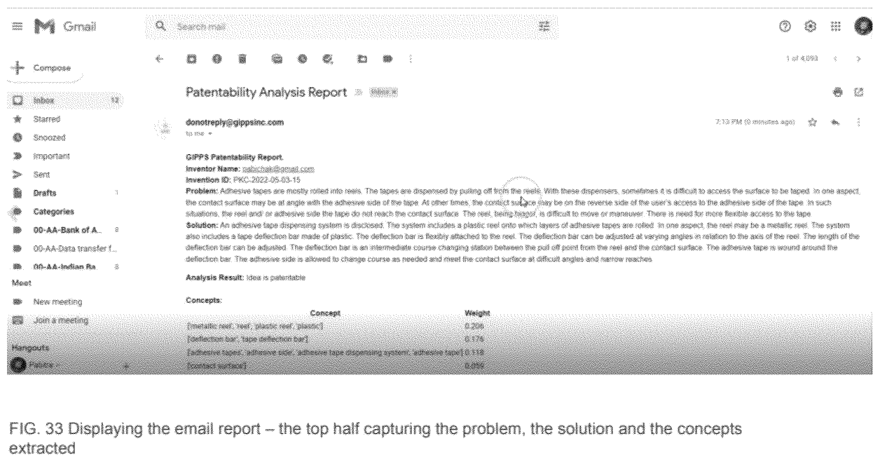

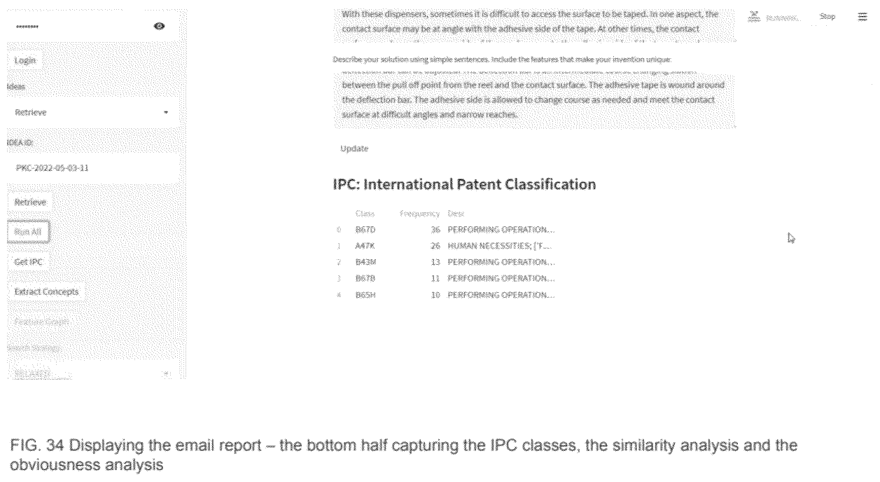

FIG. 31 is a pictorial representation of the step of email reporting of the whole working session with the invention disclosure recording and analysis. FIG. 32 illustrates a pictorial representation of the step of receiving the email report in the designated inbox of the inventor. FIG. 33 illustrates a pictorial representation of the step of displaying the email report—the top half capturing the problem, the solution and the concepts extracted. FIG. 34 illustrates a pictorial representation of the step of displaying the email report—the bottom half capturing the IPC classes, the similarity analysis and the obviousness analysis.

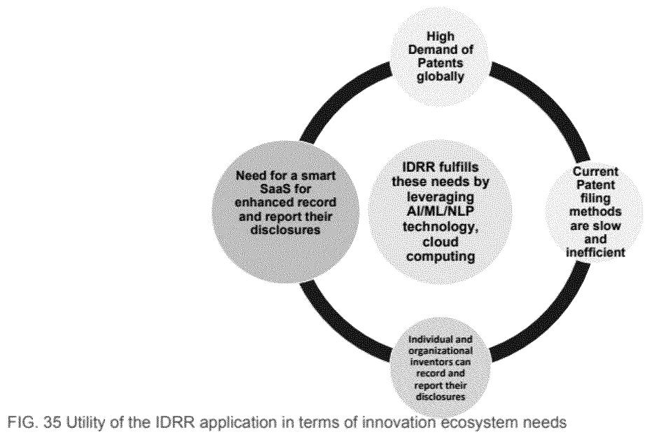

FIG. 35 is a schematic representation of the utility of the IDRR application in terms of the needs of an innovation ecosystem. Globally, there is a high demand of patents and the current patent filing methods are slow and inefficient. There is need for a smart SaaS for enhanced recording and reporting of invention disclosures by individual and organizational inventors. IDRR fulfills these needs by deploying a digital framework that leverages AI/ML/NLP technology, and cloud computing etc.

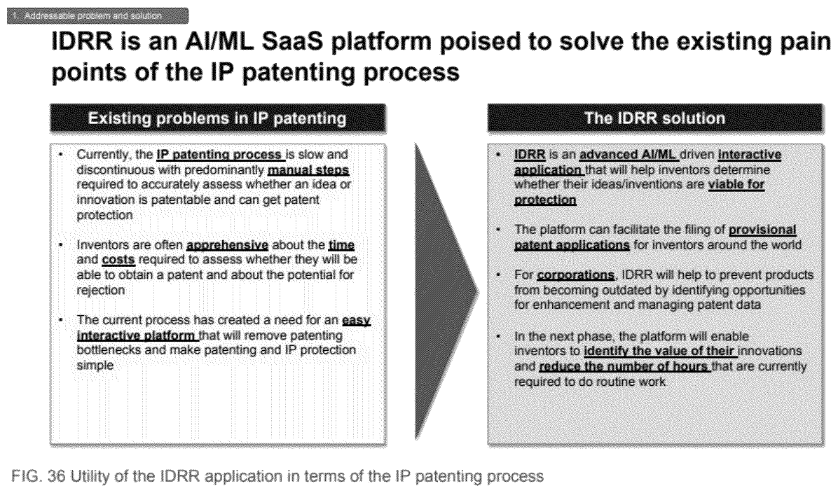

FIG. 36 is a pictorial representation of the utility of the IDRR application in terms of the IP patenting process. Currently, the IP patenting process is slow and discontinuous with predominantly manual steps required to accurately assess whether an idea or innovation is patentable and can get patent protection. Inventors are often apprehensive about the time and costs required to assess whether they will be able to obtain a patent and about the potential for rejection. The current process has created a need for an easy interactive platform that will remove patenting bottlenecks and make patenting and IP protection simple.

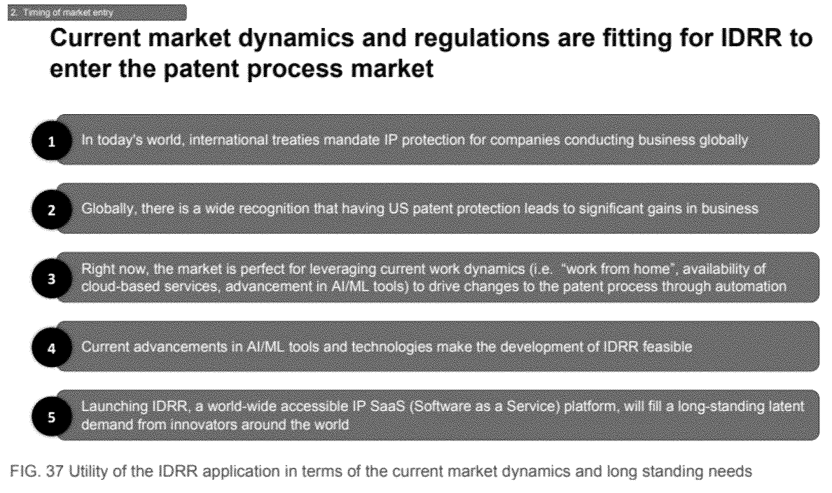

FIG. 37 is a pictorial representation of the utility of the IDRR application in terms of the current market dynamics and long standing needs. In today's world, international treaties mandate IP protection for companies conducting business globally. Globally, there is a wide recognition that having US patent protection leads to significant gains in business. Right now, the market is perfect for leveraging current work dynamics (i.e. “work from home”, availability of cloud-based services, advancement in AI/ML tools) to drive changes to the patent process through automation. Current advancements in AI/ML tools and technologies make the development of IDRR feasible. Launching IDRR, a world-wide accessible IP Saas (Software as a Service) platform, will fill a long-standing latent demand from innovators around the world.

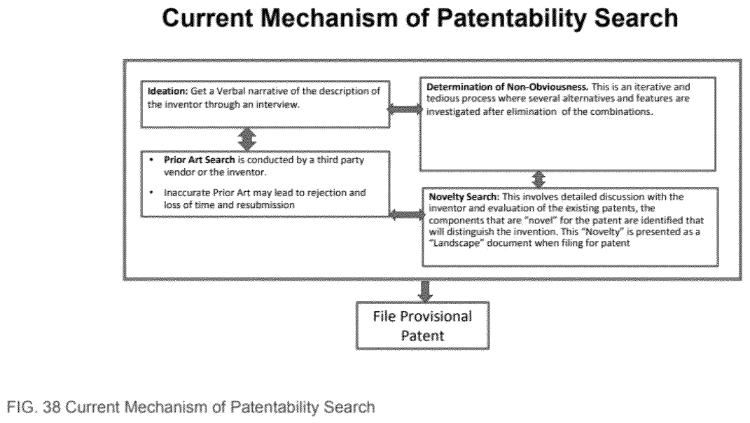

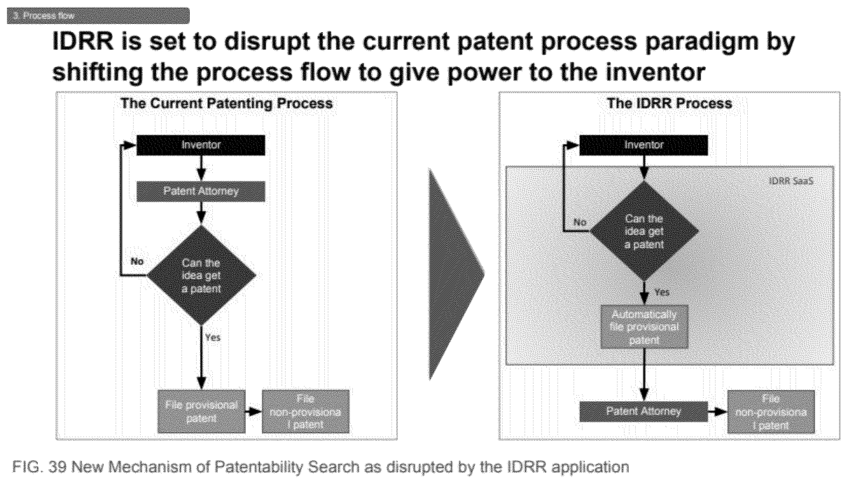

FIG. 38 is a pictorial representation of the current mechanism of patentability search, in a number of inter-related steps: (a) Ideation: Get a Verbal narrative of the description of the inventor through an interview. (b) Determination of Non-Obviousness: This is an iterative and tedious process where several alternatives and features are investigated after the elimination of the combinations. (c) Prior Art Search: This search is conducted by a third-party vendor or the inventor. Inaccurate Prior Art may lead to rejection and loss of time and resubmission. (d) Novelty Search: This search involves detailed discussion with the inventor and evaluation of the existing patents, the components that are “novel” for the patent are identified that will distinguish the invention. This “Novelty” is presented as a “Landscape” document when filing for a patent. (e) Filing: Finally, a provisional patent is filed. FIG. 39 illustrates a pictorial representation of a new mechanism of patentability search, as disrupted by the IDRR application. IDRR is set to disrupt the current patent process paradigm by shifting the process flow to give power to the inventor.

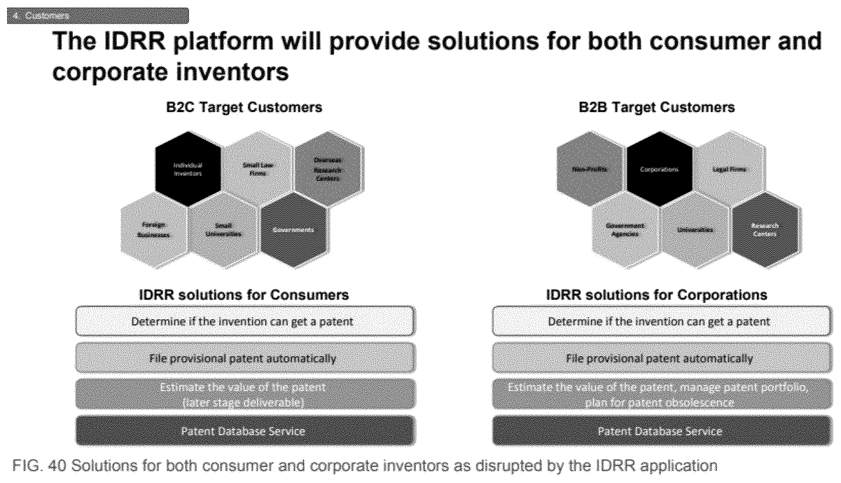

FIG. 40 is a pictorial representation of solutions for both consumer and corporate inventors as disrupted by the IDRR application. IDRR solutions for consumers include (a) determining if the invention disclosure can get a patent, (b) filing a provisional patent automatically, (c) estimating the value of the patent as a late stage development, and (d) providing patent database services. IDRR solutions for corporations include (a) determining if the invention can get a patent, (b) filing provisional patent automatically, (c) estimating the value of the patent, manage patent portfolio, plan for patent obsolescence, and (d) providing patent database services.

FIG. 41 is a pictorial representation of unexpected results derived from the IDRR system and method, in the form of huge cost benefits and time benefits for the user/inventor. In one instance, potential time savings per task, from IDRR over a typical current method are estimated to be: Patentability—from 2 Weeks to 2 Hours, Freedom to operate (FTO)—from 2 Weeks to 2 Hours, Landscape—from 2 Weeks to 2 Hours, Invalidity—from 2 Weeks to 2 Hours, Provisional Patent Application drafting—from 1 Week to 2 Hours, Non-Provisional Patent Application drafting—from 3 weeks to 8 hours, Data services—currently not offered vis-à-vis $50, Obsolescence—currently not offered vis-à-vis 2 Hours, Monetization—currently not offered vis-à-vis 2 Hours, Portfolio Management—currently not offered vis-à-vis 2 Hours.

In another instance, potential cost savings per task, from IDRR over a typical current method are estimated to be: Patentability—from $75 to $650, Freedom to operate (FTO)—from $75 to $600, Landscape—from $200 to $650, Invalidity—from $75 to $650, Provisional Patent Application drafting—from $200 to $1000, Non-Provisional Patent Application drafting—from $1000 to $5000, Data services—currently not offered vis-à-vis $50, Obsolescence—currently not offered vis-à-vis $1000, Monetization—currently not offered vis-à-vis $200, and Portfolio Management—currently not offered vis-à-vis $500.

For the customers who are Patent Attorneys, the IDRR platform will act as a dual-mode of utility and advertisement if they subscribe to the service. Any Patent Attorney firm that signs up as a subscriber will be loaded to a database that will be displayed to the Inventor users. If the inventor finds their idea patentable, they will have access to this database of lawyers for filing Provisional or Non-Provisional or both. Eventually, an auction mode will be initiated so that the inventors can select a Law Firm based on a “Low Bid” and or Credentials of the firm.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

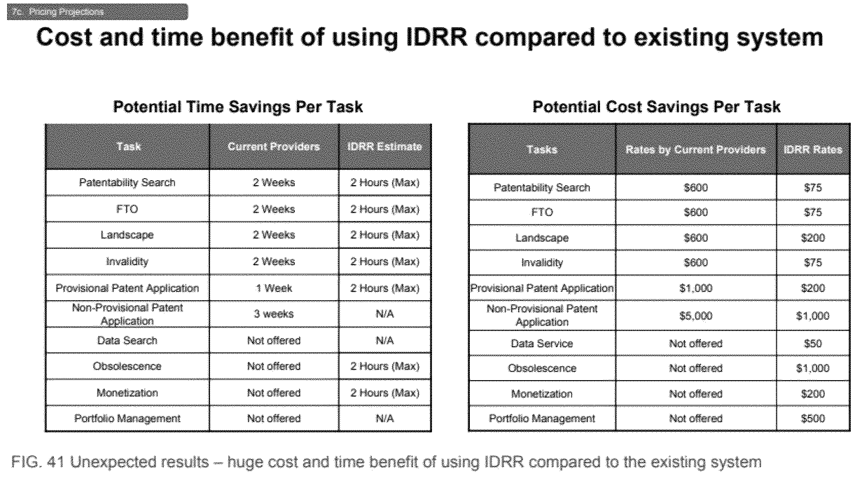

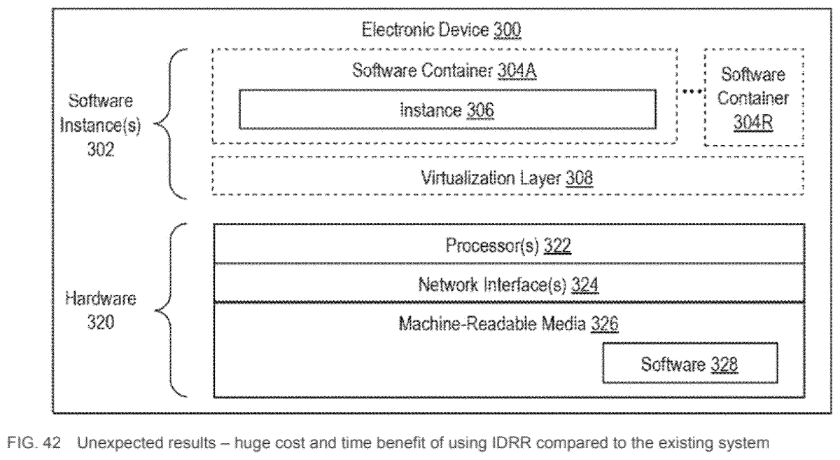

FIG. 42 is a block diagram illustrating an electronic device according to some example implementations. FIG. 42 includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

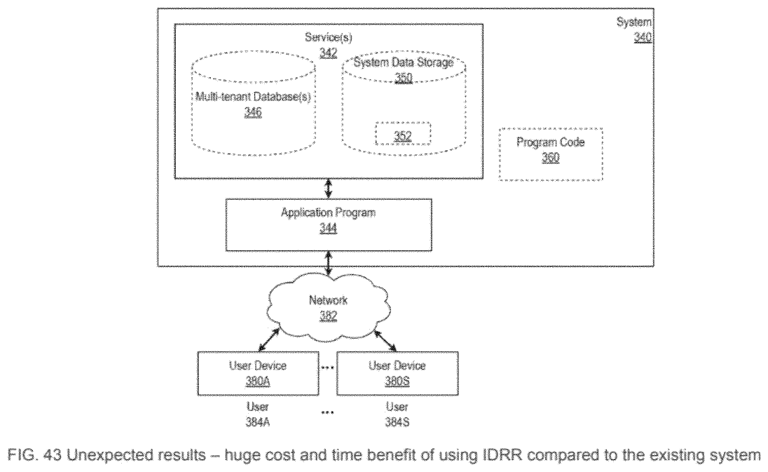

FIG. 43 is a block diagram of a deployment environment according to some example implementations. System 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. An inventor disclosure recording and reporting system comprising:
a digital framework configured to perform a cost-saving or a time-saving task for an inventor, the digital framework comprising:
a data services module configured to record, store, process and report data related to an invention disclosure of an inventor;
an ideation and patentability module configured to compare and contrast the data with prior information available from a pre-existing knowledgebase, and report at least one of a similarity status, an obviousness status, and a patentability status of the invention disclosure;
a provisional patent filing module configured to draft a paper copy and a digital copy of a provisional patent application related to the invention disclosure, based on at least one of the similarity status, the obviousness status, and the patentability status of the invention disclosure;
a non-provisional patent filing assistance module configured to draft a paper copy and a digital copy of a non-provisional patent application related to the invention disclosure, based on at least one of the similarity status, the obviousness status, and the patentability status of the invention disclosure;
a patent monetization aid module configured to compute and report a financial currency converted value of the invention disclosure, based on at least one of the similarity status, the obviousness status, and the patentability status of the invention disclosure;
a patent obsolescence planning module configured to analyze, compute and report a plurality of future states of a subject matter described in the invention disclosure; and
a patent portfolio management module configured to analyze, compute and report a plurality of portfolio jurisdictions related to each of the future states of the subject matter described in the invention disclosure.

2. A computer-implemented method of recording and reporting an inventor disclosure connected to a plurality of user devices, the method comprising:
performing a cost saving or a time saving task for an inventor using a digital framework, the performing a cost saving or a time saving task comprising:
recording, storing, processing and reporting data related to an invention disclosure disclosed by an inventor;
comparing and contrasting the data with prior information available from a pre-existing knowledgebase, and reporting at least one of a similarity status, an obviousness status, and a patentability status of the invention disclosure;
drafting a paper copy and a digital copy of a provisional patent application related to the invention disclosure, based on at least one of the similarity status, the obviousness status, and the patentability status of the invention disclosure;
drafting a paper copy and a digital copy of a non-provisional patent application related to the invention disclosure, based on at least one of the similarity status, the obviousness status, and the patentability status of the invention disclosure;
computing and reporting a financial currency converted value of the invention disclosure, based on at least one of the similarity status, the obviousness status, and the patentability status of the invention disclosure;
analyzing, computing and reporting a plurality of future states of a subject matter described in the invention disclosure; and
analyzing, computing and reporting a plurality of portfolio jurisdictions related to each of the future states of the subject matter described in the invention disclosure.

3. A non-transitory machine-readable storage medium that provides instructions that, if executed by one or more processors, are configurable to cause the one or more processors to perform operations of recording and reporting an inventor disclosure connected to a plurality of user devices, the instructions when executed using one or more processors causes the machine to perform:
a cost saving or a time saving task for an inventor using a digital framework, the cost saving or a time saving task comprising:
recording, storing, processing and reporting data related to an invention disclosure disclosed by an inventor;
comparing and contrasting the data with prior information available from a pre-existing knowledgebase, and reporting at least one of a similarity status, an obviousness status, and a patentability status of the invention disclosure;
drafting a paper copy and a digital copy of a provisional patent application related to the invention disclosure, based on at least one of the similarity status, the obviousness status, and the patentability status of the invention disclosure;
drafting a paper copy and a digital copy of a non-provisional patent application related to the invention disclosure, based on at least one of the similarity status, the obviousness status, and the patentability status of the invention disclosure;
computing and reporting a financial currency converted value of the invention disclosure, based on at least one of the similarity status, the obviousness status, and the patentability status of the invention disclosure;
analyzing, computing, and reporting a plurality of future states of a subject matter described in the invention disclosure; and
analyzing, computing and reporting a plurality of portfolio jurisdictions related to each of the future states of the subject matter described in the invention disclosure.

4. An inventor disclosure recording and reporting system connected to a plurality of user devices, the apparatus comprising:
one or more processors; and
non-transitory machine-readable storage medium that provides instructions that, if executed by one or more processors, are configurable to cause the one or more processors to perform operations of recording and reporting an inventor disclosure connected to a plurality of user devices, the instructions when executed using one or more processors causes the machine to perform:
a cost saving or a time saving task for an inventor using a digital framework, the cost saving or a time saving task comprising:
recording, storing, processing and reporting data related to an invention disclosure disclosed by an inventor;
comparing and contrasting the data with prior information available from a pre-existing knowledgebase, and reporting at least one of a similarity status, an obviousness status, and a patentability status of the invention disclosure;
drafting a paper copy and a digital copy of a provisional patent application related to the invention disclosure, based on at least one of the similarity status, the obviousness status, and the patentability status of the invention disclosure;
drafting a paper copy and a digital copy of a non-provisional patent application related to the invention disclosure, based on at least one of the similarity status, the obviousness status, and the patentability status of the invention disclosure;
computing and reporting a financial currency converted value of the invention disclosure, based on at least one of the similarity status, the obviousness status, and the patentability status of the invention disclosure;
analyzing, computing, and reporting a plurality of future states of a subject matter described in the invention disclosure; and
analyzing, computing and reporting a plurality of portfolio jurisdictions related to each of the future states of the subject matter described in the invention disclosure.
